(19) United States
(12) Patent Application Publication
(10) Pub. No.: US 2007/0177612 A1
(43) Pub. Date: Aug. 2, 2007

(54) NETWORK APPARATUS

(76) Inventor: Takashi Kubota, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/617,351

(22) Filed: Dec. 28, 2006

(30) Foreign Application Priority Data
Jan. 27, 2006 (JP) 2006-019449

(51) Int. Cl. H04L 12/56

(52) U.S. Cl. 370/395.52

(57) ABSTRACT

A network apparatus is disclosed. The network apparatus includes the following items so that a network address required for identifying the network apparatus in a network is generated, the network apparatus including
an input unit for inputting a keyword for automatic generation of a network address, and
an address generating unit for automatically generating the network address based on the input keyword.

### BACKGROUND OF THE INVENTION

1. Field of the Invention

The present invention relates to a network apparatus wherein setup and management of an IP address and the like are facilitated.

2. Description of the Related Art

The mainstream at present of the network layer protocol of the OSI (Open Systems Interconnection) reference model is IPv4 (Internet Protocol version 4) wherein an IP address is expressed with 32 bits. In view of requirements for a vast number of IP addresses in the future, IPv6 (Internet Protocol version 6) that uses 128 bits for each IP address has been introduced, and will be widely used.

Basically, an IP address of IPv6 is automatically assigned when an apparatus is connected to a network. However, there are cases wherein an IP address is to be manually set up, for example, when assigning a fixed IP address to a server.

In the conventional IPv4, an IP address is expressed by decimal numbers for every 8 bits, for example “192.168.0.1”. In IPv6, an IP address is expressed by hexadecimal numbers for every 16 bits delimited with colons “:”, for example “3ae3:90a0:bd05:01ad:00ad:9090:80a7:1234”.

[Patent reference 1] JPA 2004-056477

[Patent reference 2] JPA 2002-281267

As described above, there are cases wherein a fixed IP address has to be manually set up. In the case of Ipv4, the address is short, and it is possible for a user to manually set up the IP address from memory. However, in IPv6, since the address is long, it is difficult, nearly impossible to remember and manually set up the IP address. Manual setting of an IPv6 address may be carried out by looking at a memorandum, etc.; however, this easily causes a mistake.

Accordingly, an IP address setup method other than a direct manual setup is desired such that usability of IPv6 is equivalent to or even better than IPv4.

Patent Reference 1 discloses a technique of generating an IPv6 address based on time information at the time of setup, and a counter of a clock pulse. In this way, an IPv6 address, which is hard to be associated with hardware, is generated. This technique simplifies setting up an IP address; however, it does not solve the problem of a manual setup of a fixed IP address.

Patent Reference 2 discloses a technique of automatically generating an IP address based on an MAC (Media Access Control) address for mitigating the difficulty in parameter setup of a network facsimile. (Automatic generation of an IP address based on a Media Access Control Address is a standard function in IPv6.) Although this technique simplifies the setup work, it does not aim at automatic generation of an IP address. Further, since the IP address is generated based on the Media Access Control address unique to an apparatus, this technique cannot be applied to assigning an IPv6 address that is desired from the viewpoint of network apparatus management.

### SUMMARY OF THE INVENTION

Embodiments of the present invention provide a network apparatus that substantially obviates one or more of the problems caused by the limitations and disadvantages of the related art.

Specifically, in view of the problems described above, the present invention offers a network apparatus wherein a network address such as an IPv6 address can be easily set up, facilitating network management jobs.

Features of the embodiments of the present invention are set forth in the description that follows, and in part will become apparent from the description and the accompanying drawings, or may be learned by practice of the invention according to the teachings provided in the description. Problem solutions provided by the embodiments of the present invention may be realized and attained by a network apparatus particularly pointed out in the specification in such full, clear, concise, and exact terms as to enable a person having ordinary skill in the art to practice the invention.

To achieve these solutions and in accordance with an aspect of the invention, as embodied and broadly described herein, the embodiments of the present invention provide a network apparatus that is assigned a unique network address for identifying the network apparatus in a network as follows.

### [Means for Solving a Subject]

The network apparatus includes an input unit for inputting a keyword for automatically generating the network address, and a network address generating unit for automatically generating the network address based on the keyword that is input by the input unit.

According to another aspect of the present invention, the network address is an IP address of IPv6 that is the protocol of the Network Layer of the OSI reference model.

According to another aspect of the present invention, the keyword for automatically generating the network address is any desired character string.

According to another aspect of the present invention, the keyword for automatically generating the network address is apparatus setup information of the network apparatus.

According to another aspect of the present invention, the keyword for automatically generating the network address is network setup information of the network apparatus.

According to another aspect of the present invention, the keyword for automatically generating the network address is apparatus setup information assigned to a managing apparatus that is connected to the network for assigning the network address to the network apparatus.

According to another aspect of the present invention, the keyword for automatically generating the network address is network setup information applied to the managing apparatus.

According to another aspect of the present invention, the keyword for automatically generating the network address is an address generating function that can be replaced.

According to another aspect of the present invention, the network apparatus includes a duplication detecting unit that determines whether a network address generated based on the input keyword for automatically generating a network address is already used in the same network. Further, the duplication detecting unit provides a notification if the determination is affirmative; and the duplication detecting unit provides another similar keyword that may give an available network address.

According to another aspect of the present invention, the network apparatus includes a duplication detecting unit that determines whether a network address generated based on the input keyword for automatically generating a network address is already used in the same network. Further, the duplication detecting unit provides a notification if the determination is affirmative; and the duplication detecting unit provides another available network address.

According to another aspect of the present invention, a network address setting method is provided, which method is for setting up a network address in a network apparatus that has to be assigned a unique network address. The network setting method includes a step of inputting a keyword for automatically generating a network address, and a step of automatically generating the network address based on the input keyword.

[Effectiveness of Invention]

According to the network apparatus of the present invention, a network address, such as an IPv6 address, can be easily set up, and management work thereof is facilitated.

### BRIEF DESCRIPTION OF THE DRAWINGS

FIG. 1 is a block diagram showing an exemplary configuration of a network apparatus according to an embodiment of the present invention;

FIG. 2 is a block diagram showing an exemplary configuration of communication control software;

FIG. 3 is a block diagram showing an exemplary configuration of communication control software according to the first embodiment of the present invention;

FIG. 4 is a block diagram showing an exemplary configuration of an IP address generating unit;

FIG. 5 is a flowchart showing an exemplary process performed by the IP address generating unit;

FIG. 6 is a sequence chart showing sequences of the process performed by the IP address generation unit;

FIG. 7 shows an example (part 1) of a keyword input screen for an IP address setup by a Web page;

FIG. 8 shows the example (part 2) of the keyword input screen for the IP address setup by the Web page;

FIG. 9 shows the example (part 3) of the keyword input screen for the IP address setup by the Web page;

FIG. 10 shows the example (part 4) of the keyword input screen for the IP address setup by the Web page;

FIG. 11 shows the example (part 5) of the keyword input screen for the IP address setup by the Web page;

FIG. 12 a block diagram showing an exemplary configuration of the communication control software according to the second embodiment of the present invention;

FIG. 13 is a block diagram of an example of an IP address generating function that can be replaced, according to the second embodiment;

FIG. 14 shows an example of a keyword input screen for an IP address setup by a Web page, according to the second embodiment;

FIG. 15 is a block diagram showing an exemplary configuration of the IP address generating unit according to the third embodiment of the present invention;

FIG. 16 shows an example of a notice when an IP address overlaps another;

FIG. 17 shows an example of a notice prompting for an alternative keyword;

FIG. 18 is a block diagram showing an exemplary configuration of the IP address generating unit according to the fourth embodiment of the present invention;

FIG. 19 shows an example of the notice when the IP address overlaps another; and

FIG. 20 shows an example of the notice prompting for the alternative keyword.

### DESCRIPTION OF THE PREFERRED EMBODIMENTS

In the following, embodiments of the present invention are described with reference to the accompanying drawings.

Here, the embodiments as applied to IPv6 are described; nevertheless, the present invention can be adapted to protocols other than IPv6. Further, the embodiments as applied to a network apparatus are described; nevertheless, the present invention can be adapted to a network management system for managing a network based on a keyword assigned to each network apparatus.

<Fundamental Configuration of a Network Apparatus>

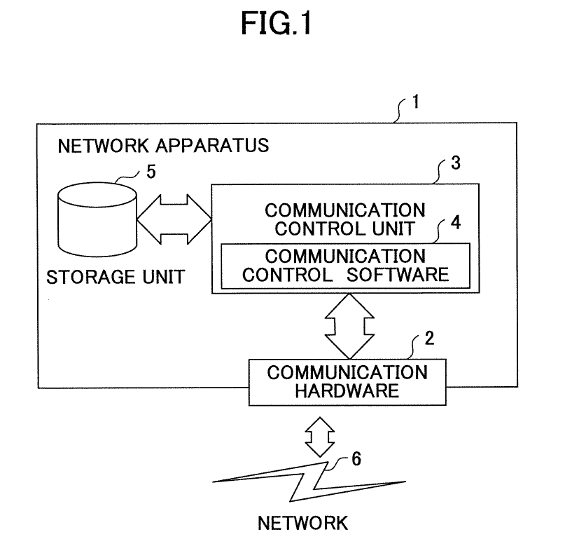

FIG. 1 is a block diagram showing an exemplary configuration of a network apparatus 1 according to the embodiment of the present invention. The network apparatus 1 includes

communications hardware 2 for communication with an external apparatus through a network 6,

a communication control unit 3 for controlling communications with the exterior through the communication hardware 2, and

a storage unit 5 for storing setup information, such as an IP address and a subnet mask, of the network apparatus 1.

The communication control unit 3 carries out processes of standard protocols (such as IPv4, IPv6, and TCP). There are apparatuses that perform processes of other than the standard protocols, namely, packet filtering, port mapping, non-standard protocols, and the like.

The configuration shown in FIG. 1 is the minimum; a network apparatus with more functions can be realized by adding other functional units. For example, by adding an application unit to the upper part of the communication control unit 3, a network apparatus that performs processes based on communications can be configured, for example, an apparatus that displays information, and an apparatus that provides music based on information acquired from the network.

Operations of the communication control unit 3 are carried out according to the communication control software 4. Nevertheless, the operations may be realized by hardware so that operating speed is increased.

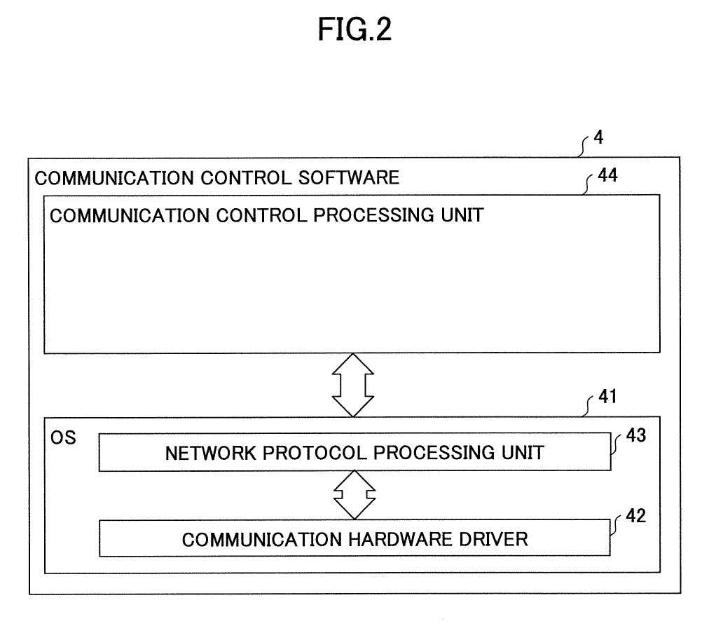

FIG. 2 is a block diagram showing an exemplary configuration of the communication control software 4 that includes an OS (Operating System) 41 and a communication control processing unit 44.

The OS 41 includes a communication hardware driver 42 for directly operating communication hardware, and a network protocol processing unit 43 for performing a standard protocol process. Further, the communication control processing unit 44 that operates on the OS 41 performs communication processes other than the standard protocol process.

### The First Embodiment

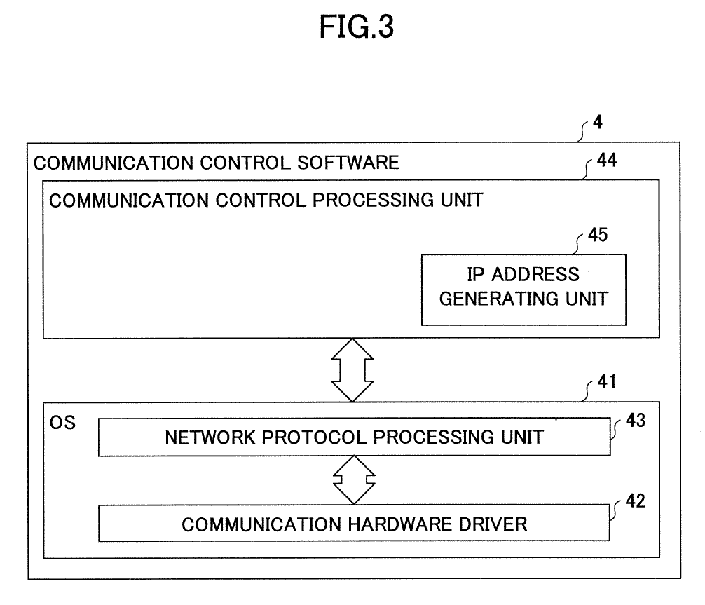

FIG. 3 is a drawing showing a configuration example of the communication control software 4 according to the first embodiment of the present invention. As shown in FIG. 3, the communication control processing unit 44 includes an IP address generating unit 45. Otherwise, the communication control software 4 is the same as shown in FIG. 2.

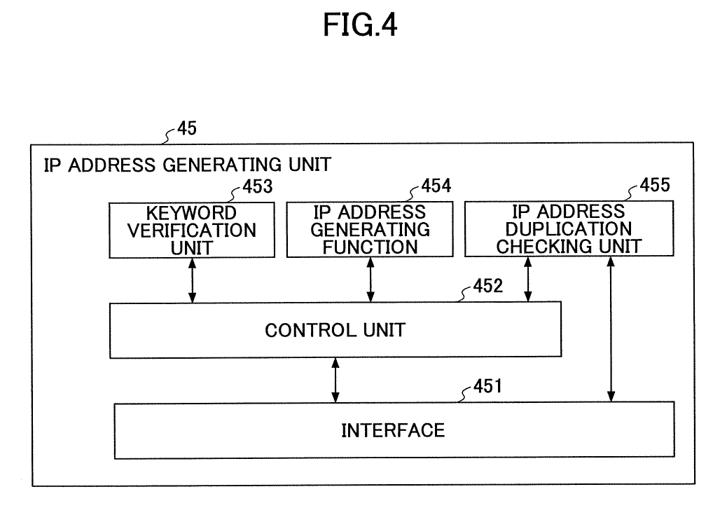

FIG. 4 is shows a configuration example of the IP address generating unit 45 that includes an interface 451 for interfacing with an external module, and a control unit 452 for controlling all operations of IP address generation, which generation is carried out using other modules of the IP address generating unit 45. Here, the control unit 452 performs suitable management when the modules of the IP address generating unit 45 return an error in processing, which suitable management includes suspension of IP address generation and re-execution after an adjustment.

Further, the IP address generating unit 45 includes a keyword verification unit 453 for determining whether a keyword that serves as a seed for the IP address generation can be used for the IP address generation, an IP address generating function 454 for generating an IP address based on the keyword, and an IP address duplication checking unit 455 for outputting a packet through the interface 451 to determine whether the generated IP address is already used in the same network.

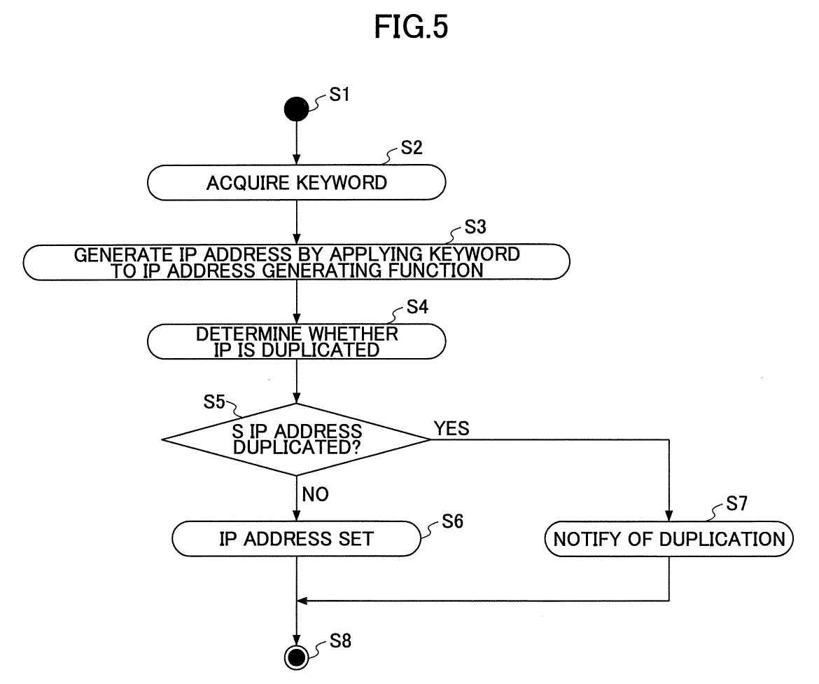

FIG. 5 is a flowchart showing an example process carried out by the IP address generating unit 45. As shown in FIG. 5, when the process is started (step S1), a keyword provided by a user is acquired (step S2). Then, the keyword verification unit 453 determines whether the keyword can be used for the IP address generation.

Then, the keyword is provided to the IP address generating function 454 so that an IP address is generated (step S3). Here, the range of the IP address to be generated can be predetermined; for example, the range can be the whole IPv6 address, or alternatively, it can be limited to interface IDs within the IPv6 addresses.

Subsequently, the IP address duplication checking unit 455 determines whether the generated IP address is duplicated (steps S4 and S5). If the determination is negative, i.e., there is no duplication of the IP address, the IP address is set up (step S6). Otherwise, if there is duplication, the user is notified of the duplication (step S7), and the process is terminated (step S8).

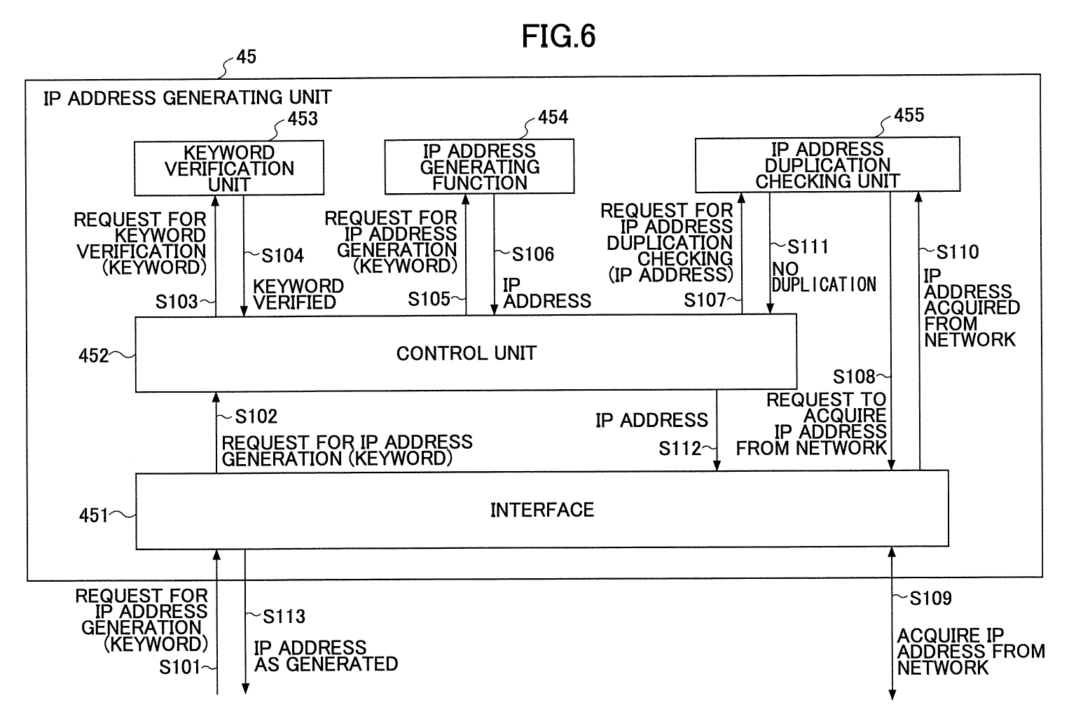

FIG. 6 shows the process sequence carried out by the IP address generating unit 45. As shown in FIG. 6, when the interface 451 of the IP address generating unit 45 receives an IP address generation request accompanied by the keyword (step S101), the IP address generation request is provided to the control unit 452 (step S102), and the control unit 452 provides a keyword verification request accompanied by the keyword to the keyword verification unit 453 (step S103).

The keyword verification unit 453 determines whether the character string of the keyword is legal as a keyword. If, for example, the keyword includes a blank, or if the keyword is constituted by only marks (not letters), the keyword is determined to be illegal. If the determination is that the keyword is legal, “keyword OK” is provided to the control unit 452 (step S104).

Subsequently, the control unit 452 provides the IP address generation request accompanied by the keyword to the IP address generating function 454 (step S105), and the IP address generating function 454 generates the IP address with a one-way function, and the like, and provides the IP address to the control unit 452 (step S106).

Then, the control unit 452 provides an IP address duplication check request to the IP address duplication checking unit 455 (step S107). The IP address duplication checking unit 455 attempts to acquire the IP address in the same network through the interface 451 (steps S108 through S110). If no duplication is found, the fact is provided to the control unit 452 (step S111).

The control unit 452 outputs the IP address that is not duplicated through the interface 451 (steps S112 and S113).

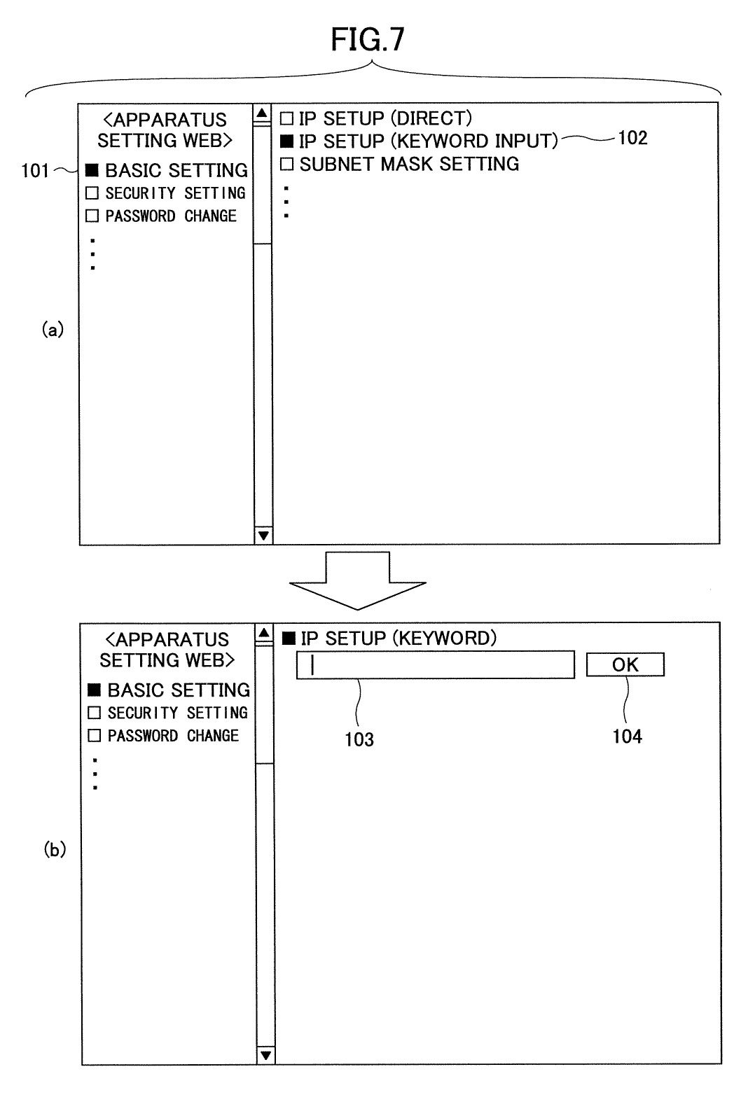

FIGS. 7 through 11 show an example of a screen display based on a Web page for inputting a keyword for an IP address selection. Here, the keyword input screen for setting up an IP address is displayed on an operations panel of the network apparatus 1, or alternatively, on a monitor of a PC (personal computer) connected to the network apparatus 1 via the network.

FIG. 7 shows an example of the keyword input screen for setting up an IP address by directly inputting a keyword. At the top part of FIG. 7 (identified by (a)), “Basic setup” 101 is chosen in the left frame of the screen, and “IP setup (keyword input)” 102 is chosen in the right frame. Then, the display is changed as shown at the bottom of FIG. 7 (identified by (b)); specifically, a keyword input column 103 and an OK button 104 are displayed. In this way, the user is prompted to input a desired keyword to the keyword input column 103, and pushing the OK button 104 completes the keyword input operation.

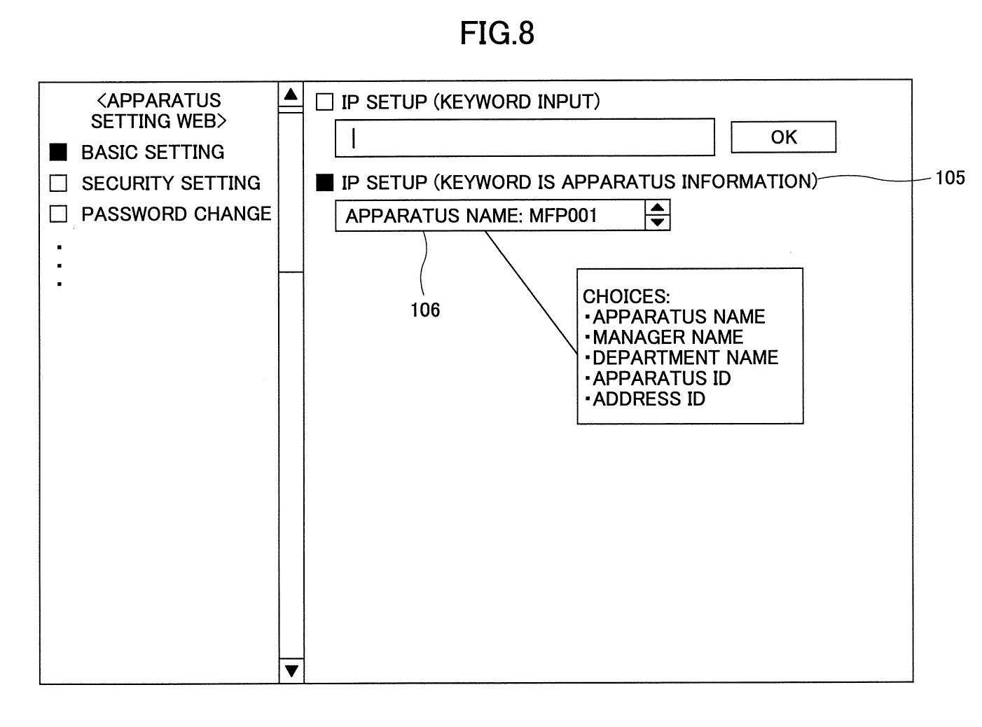

FIG. 8 shows an example of inputting apparatus information as the keyword. In the right frame of the screen, “IP setup (use apparatus information as the keyword)” 105 is chosen, and an apparatus information selection box 106 becomes effective. Further, the apparatus information selection box 106 can offer choices such as an apparatus name, manager's name, a department name, an apparatus ID, and an address ID. The user is to choose a desired one for the apparatus information from the apparatus information selection box 106, and the input of a keyword is completed.

In the present example (FIG. 8), an IPv6 address can be assigned based on the setup information on the apparatus, so that time and effort conventionally required for keyword inputting can be saved. Accordingly, the efficiency of setting up is increased. Further, since an assigning policy of the IPv6 address for apparatuses that belong to a certain network can be unified, network management can be simplified. Furthermore, the same IP address can always be assigned to the same apparatus, and IP address management can be simplified. In addition, since an apparatus setting person can correct the setup information of an apparatus, unlike a Media Access Control address, the IP address management as desired by an apparatus setting person is possible.

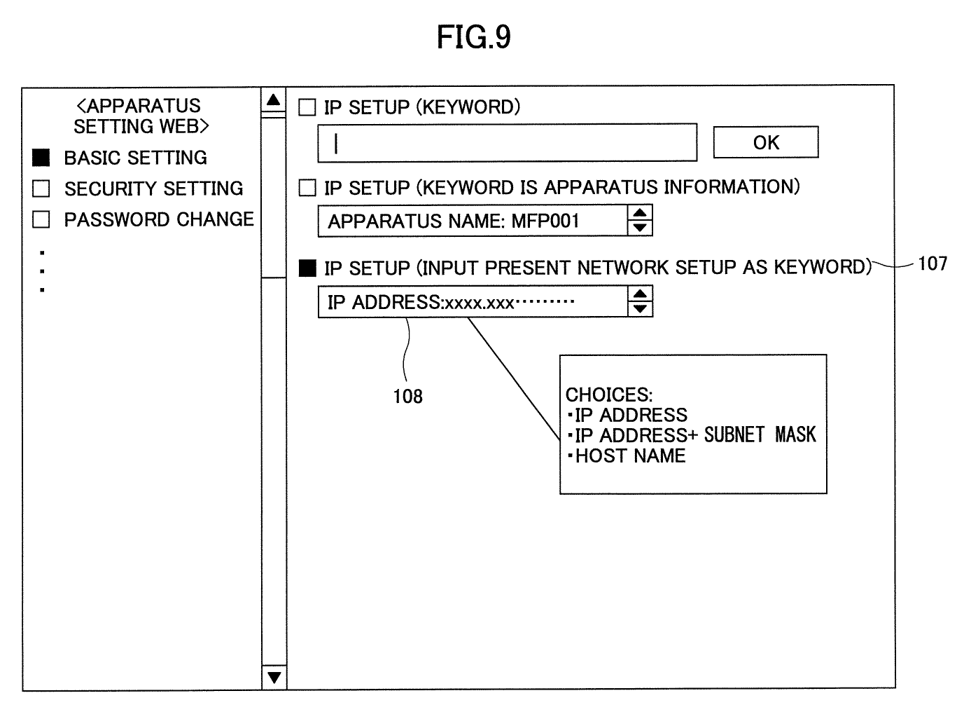

FIG. 9 shows an example of inputting a present network setup as the keyword. In the right frame of the screen, “IP setup (input the present network setup as the keyword)” 107 is chosen, and a network setting selection box 108 becomes effective. Here, the network setting selection box 108 offers choices of such as an IP address, IP address+subnet mask, a host name, and a NetBIOS name. Further, a setup of IPsec (Internet Protocol security) used for encryption may be used as the network setup information. When the user makes a choice from the network setting selection box 108, inputting of the keyword is completed.

In the present example (FIG. 9), since an IPv6 address can be assigned based on the network setup information of the apparatus, the time and effort of conventional keyword inputting can be saved and the efficiency of the setup is increased. Further, since a new IP address can be set based on the network information so far applicable to the network apparatus, when the network is changed (such as a network-protocol change from IPv4 to IPv6), the IP address assigned to each apparatus can be uniformly understood, and the network management work at the time of the network change can be simplified. Further, the IP address of the network after the change can be assigned based on a desired policy.

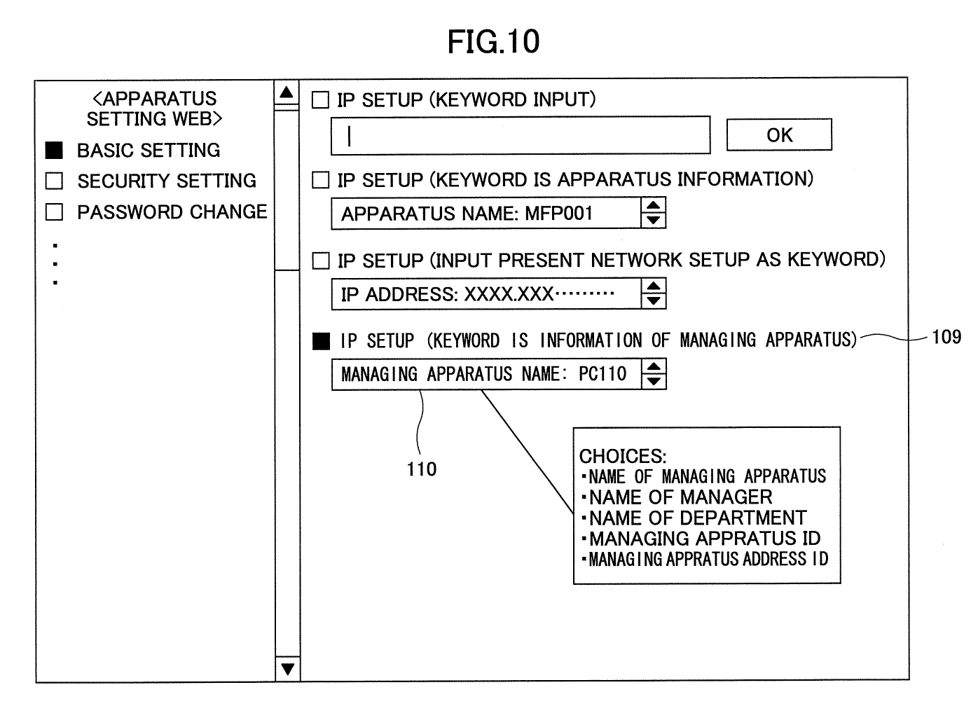

FIG. 10 shows an example of inputting information of a managing apparatus as the keyword, which managing apparatus is an apparatus of setting origin. In the right frame of the screen, “IP setup (inputting information of managing apparatus as the keyword)” 109 is chosen, and a managing apparatus information selection box 110 becomes effective. Here, the managing apparatus information selection box 110 offers choices of such as a managing appratus name, a manager name, a department name, a managing appratus ID, and a managing apparatus address ID. When a choice is made by the user from the managing apparatus information selection box 110, inputting of the keyword is completed.

According to the present example (FIG. 10), different IP addresses can be assigned to one network apparatus for every transmitting apparatus, every transmitting user, and every transmitting group, given that two or more IP addresses can be assigned to one network apparatus in an IPv6 environment. In this way, the different IP addresses can be used corresponding to destination IP addresses of a packet such that transmitting apparatuses, transmitting users, and transmitting groups may be distinguished. This feature is desired, for example, when a multi-user application is installed, and when users are to be identifiable.

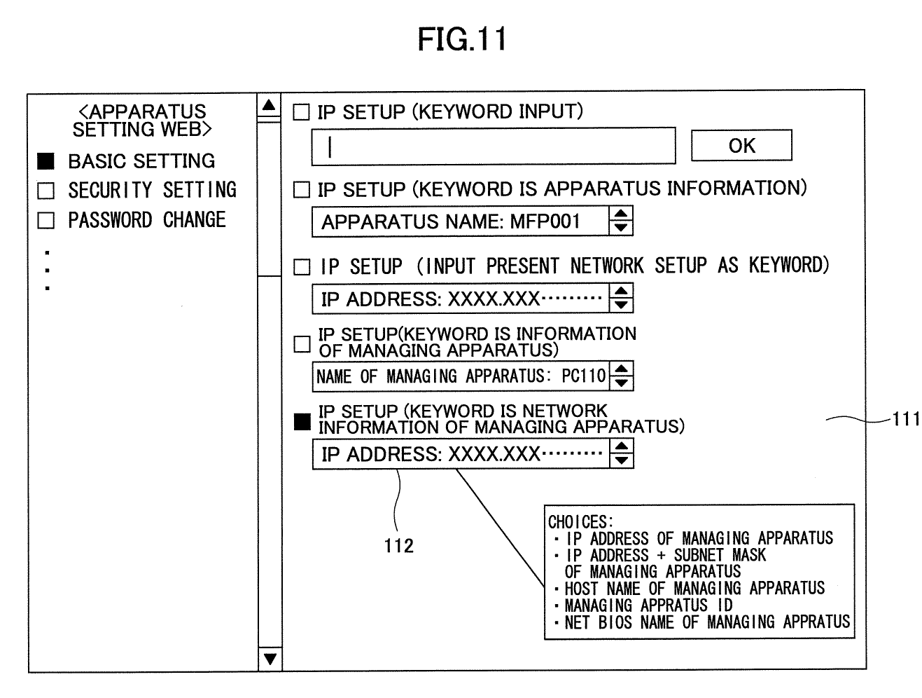

FIG. 11 shows an example of inputting network information of the managing apparatus as the keyword. In the right frame of the screen, “IP setup (input network information of managing apparatus as the keyword)” 111 is chosen, and the managing apparatus network information selection box 112 becomes effective. Here, the managing apparatus network information selection box 112 offers choices such as a managing apparatus IP address, managing apparatus IP address+subnet mask, a managing apparatus host name, and a managing apparatus NetBIOS name. When the user makes a choice in the managing apparatus network information selection box 112, inputting of the keyword is completed.

According to the present example (FIG. 11), different IP addresses can be assigned to the network apparatus for every transmitting network apparatus and every transmitting network. Given that two or more IP addresses may be assigned to one network apparatus in the IPv6 environment, the network apparatus can use the different IP addresses according to situations where it is desired to distinguish a transmitting network apparatus and a transmitting network from a destination IP address of a packet.

As described above, according to the first embodiment of the present invention, a network apparatus can be provided with an IPv6 address by inputting the keyword that is easy to handle and is easy to manage as compared with directly handling an IPv6 address. In this way, IP address setting and IP address management are facilitated.

Further, the embodiment offers wide options of keyword inputting methods for generating an IPv6 address.

### The Second Embodiment

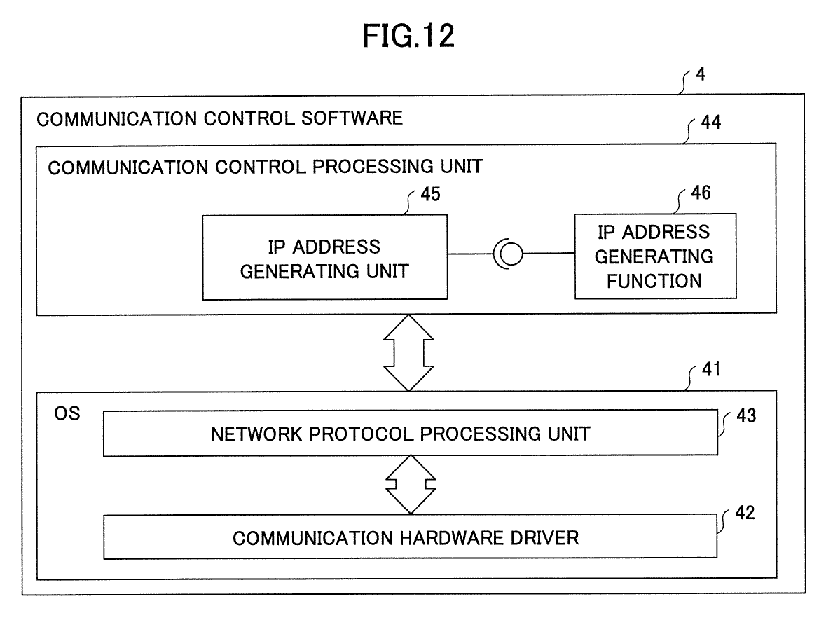

FIG. 12 is a block diagram of a configuration example of the communication control software 4 according to the second embodiment of the present invention. As shown in FIG. 12, an IP address generating function 46 is separated from the IP address generating unit 45 of the communication control processing unit 44, where the IP address generating function 46 is a replaceable unit. Otherwise, the communication control software 4 of the second embodiment is the same as the first embodiment as shown in FIG. 3.

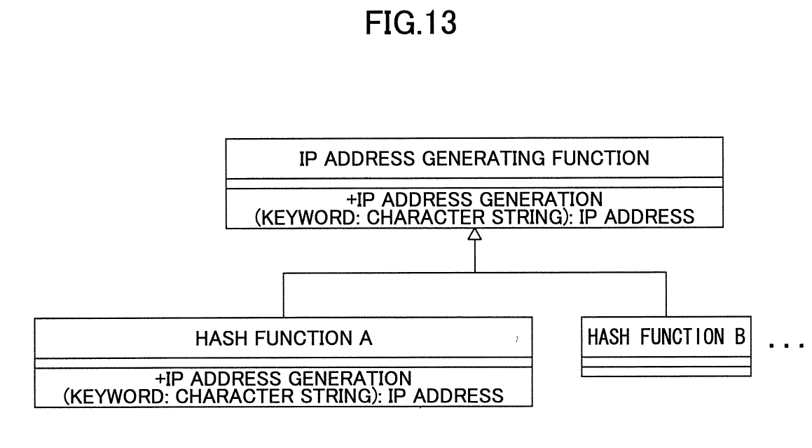

FIG. 13 is a block diagram of an example of the IP address generating function 46 for generating an “IP address generating function” class, which is an abstract class, using an object oriented design, and for defining an interface. Further, as subclasses of the “IP address generating function” class, IP address generating functions such as a “Hash Function A”, and “Hash Function B” are included. In this way, IP address setting up of the network apparatus 1 is carried out using the IP address generating function 46 that is replaceable.

Here, there are no special requirements as for the IP address generating function as long as an IP address can be generated based on a keyword. Nevertheless, if the function always generates the same IP address when the same keyword is input, IP address management is easier. Further, if the function is capable of inversely transforming the original keyword from the generated IP address, keyword management is facilitated. Further, it is also possible to assign a temporary IP address based on a function that does not require a special keyword, but generates a random IP address.

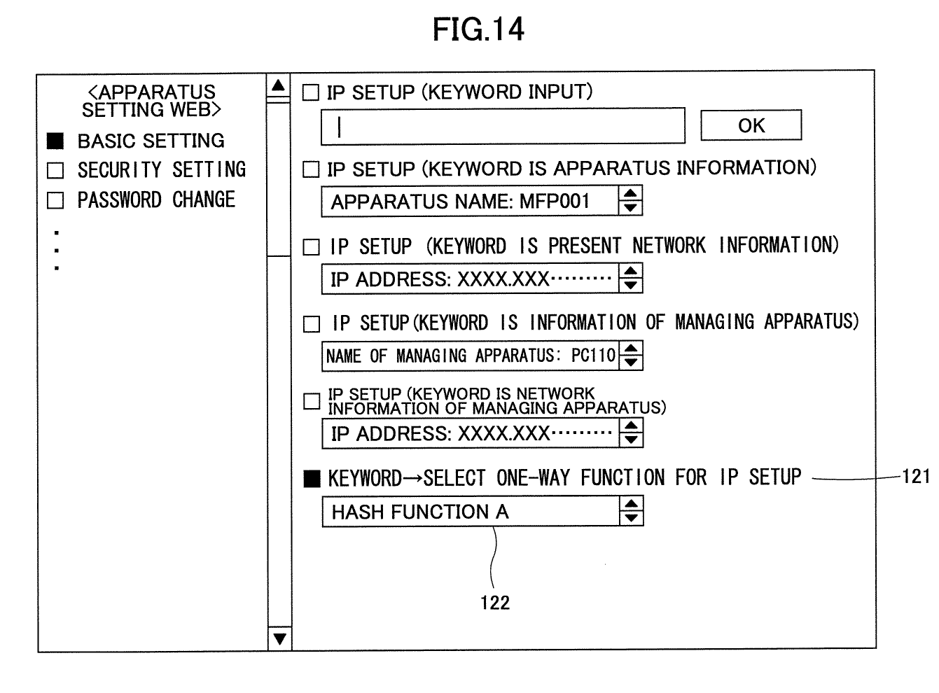

FIG. 14 shows an example of the keyword inputting screen for setting up an IP address by the Web page. In the right frame of the screen shown in FIG. 14, “Keyword ->the one-way function setup for IP setup” 121 is chosen, and a function selection box 122 becomes effective. Then, the user chooses a desired IP address generating function such as a Hash function A.

According to the second embodiment, the IP address generating function is replaceable; for this reason, the IP address can be generated based on a policy that is suitable for each network.

### The Third Embodiment

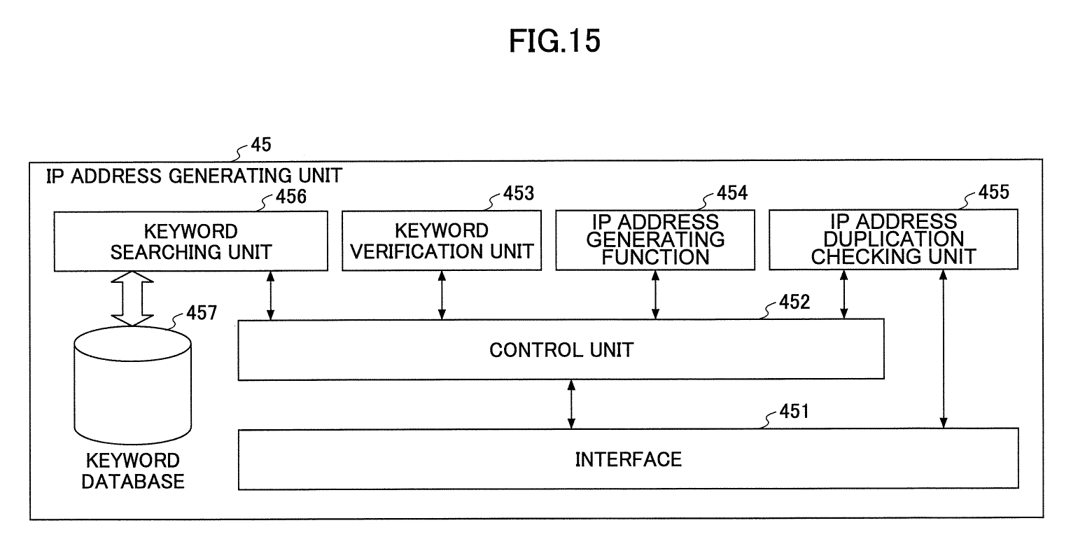

FIG. 15 is a block diagram of a configuration example of the IP address generating unit 45 according to the third embodiment of the present invention. As shown in FIG. 15, the IP address generating unit 45 includes a keyword searching unit 456 that searches for and presents an alternative keyword that can be assigned when the generated IP address is already in use (duplicated), and a keyword database 457 for storing keywords that have been assigned. Otherwise, the configuration is the same as shown in FIG. 4.

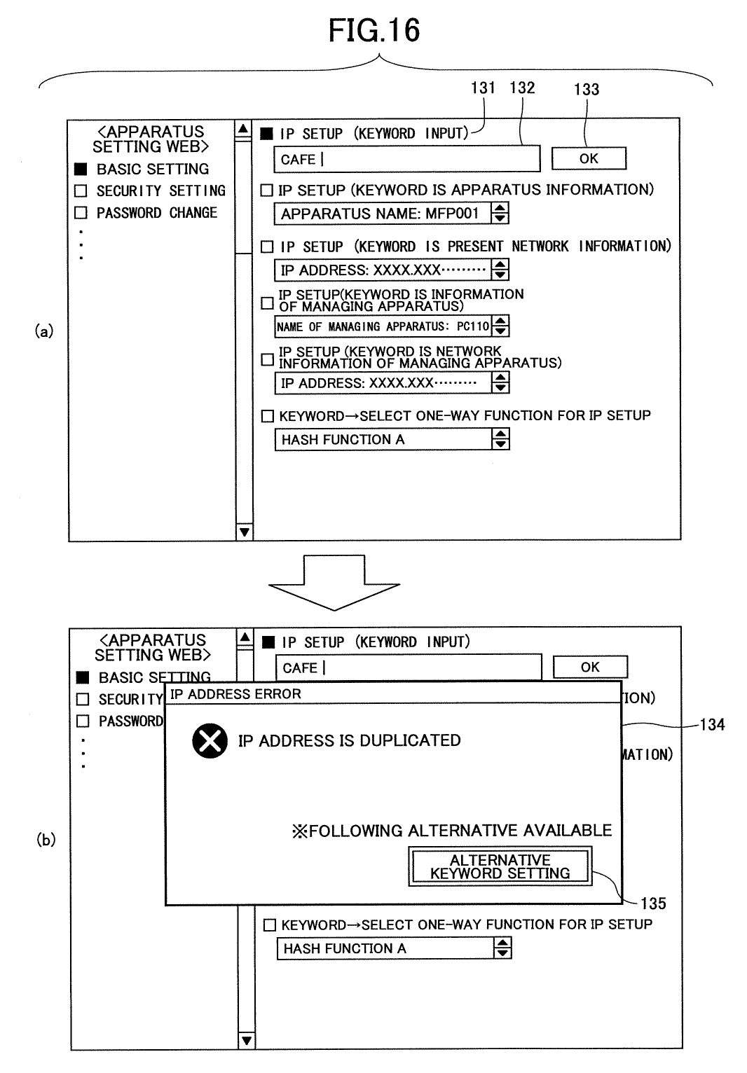

FIG. 16 shows an example of a notice screen when a proposed IP address is already in use. Specifically, at the top part of FIG. 16 (identified as (a)), “IP setup (keyword input)” 131 is chosen, a keyword is input to a keyword input column 132, and an OK button 133 is pushed; then an IP address is generated. If the generated IP address is already in use (duplicated), a dialog box 134 announcing that the IP address is already in use pops up as shown at the bottom of FIG. 16 (identified as (b)). The dialog box 134 includes an alternative keyword setting button 135.

When the alternative keyword setting button 135 is pushed, the keyword searching unit 456 offers an alternative keyword that is similar to the previously input keyword, and can generate an IP address that is not duplicated. Here, a keyword that is not stored in the keyword database 457 is offered.

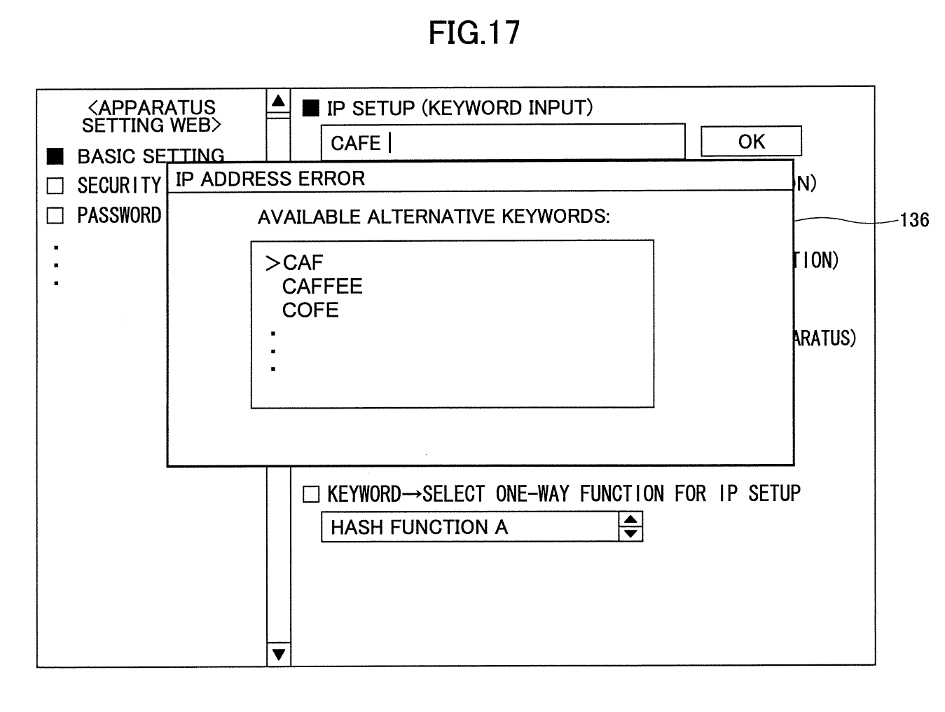

FIG. 17 shows an example of a notice screen of the alternative keyword, wherein one or more available keywords that are similar to the originally input keyword are offered for selection in a dialog box 136.

According to the present example, the user (apparatus setting person) is notified of the fact that the generated IP address corresponding to the keyword is not available, because it is already in use (duplicated), and a similar keyword that provides a unique IP address is offered. In this way, problems due to a duplicated IP address are prevented. Further, an efficient IP address setup at the time of address duplication is possible, and the IP address management by the keyword can be efficiently put into practice at the time of duplication.

### The Fourth Embodiment

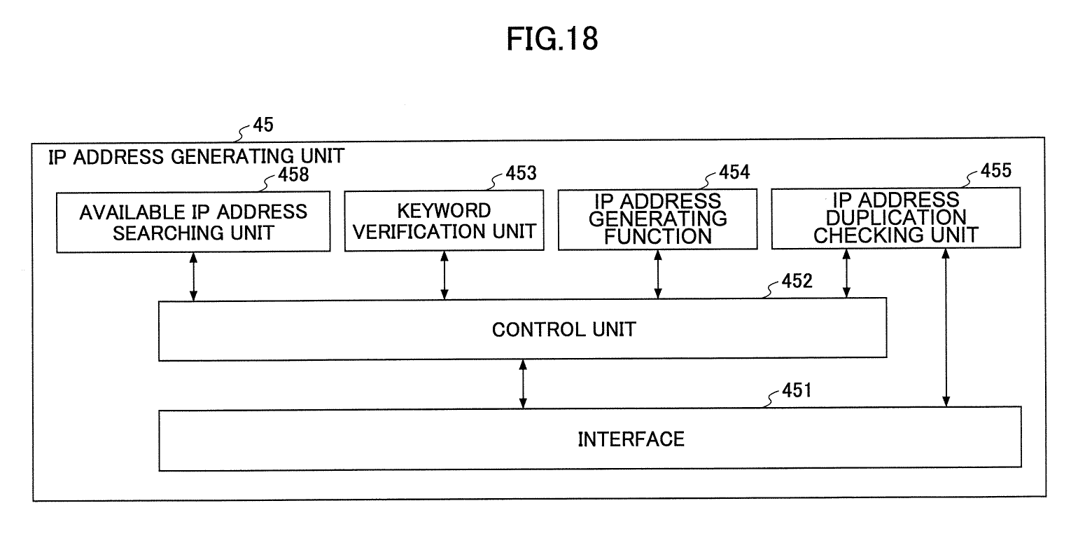

FIG. 18 is a block diagram of a configuration example of the IP address generating unit 45 according to the fourth embodiment of the present invention. As shown in FIG. 18, the IP address generating unit 45 includes an available IP address searching unit 458 that searches for and presents an available IP address when the generated IP address is already in use (duplicated). Otherwise, the configuration is the same as shown in FIG. 4.

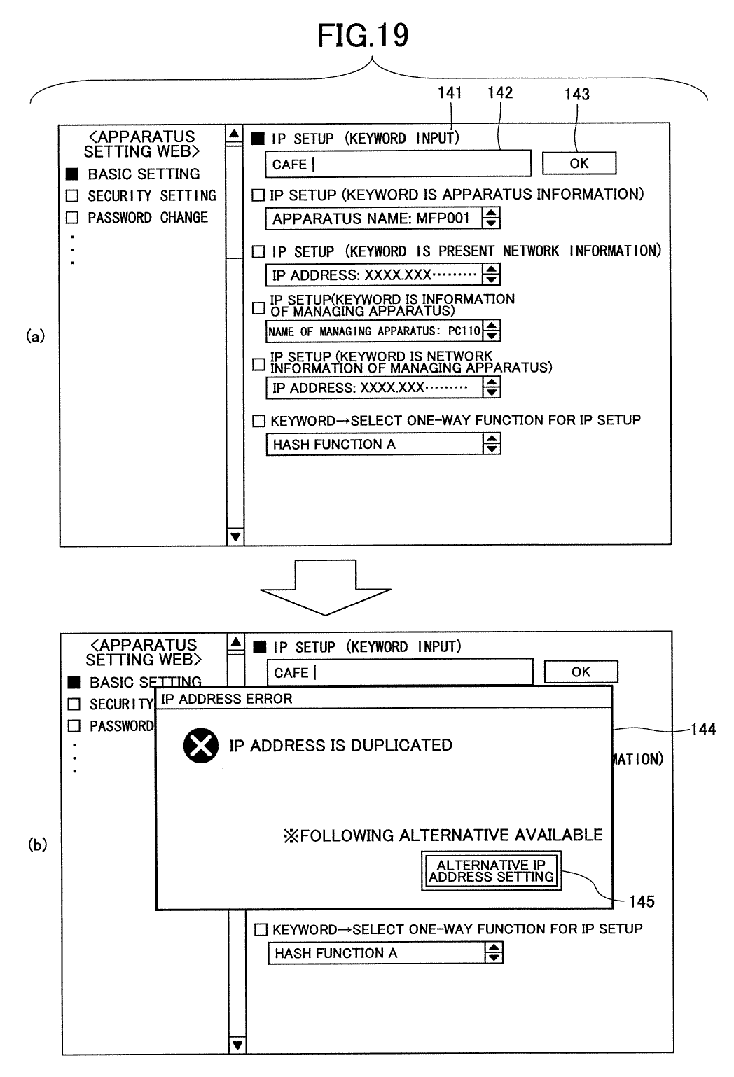

FIG. 19 shows an example of the notice screen when a generated IP address is already in use. In the top part of FIG. 19 (identified as (a)), “IP setup (keyword input)” 141 is chosen, a keyword is input to a keyword input column 142, and an OK button 143 is pushed. Then, an IP address is generated. If the generated IP address is already in use, a dialog box 144 announcing that the generated IP address is duplicated is displayed as shown in the bottom part of FIG. 19 (identified as (b)). The dialog box 144 includes an alternative IP address setting button 145.

When the alternative IP address setting button 145 is pushed, the available IP address searching unit 458 offers one or more available IP addresses that are not duplicated.

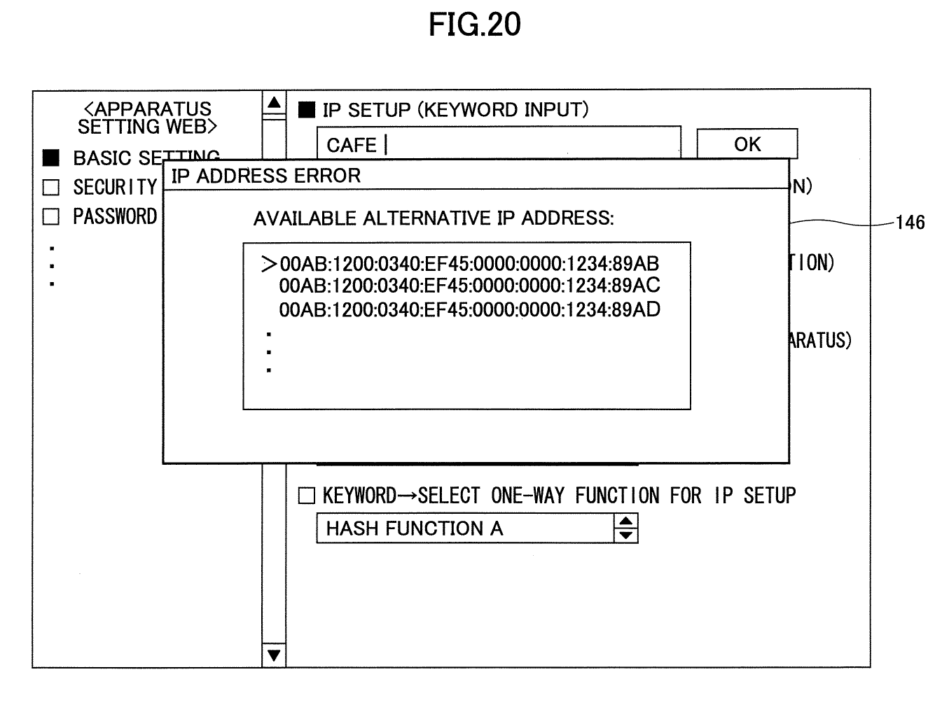

FIG. 20 shows an example of the notice screen wherein the alternative IP addresses are displayed in a dialog box 146.

According to the present example, the user (apparatus setting person) is notified of the fact that the generated IP address is already in use and is not available, and an alternative unique IP address is offered. In this way, problems due to a duplicated IP address are prevented. Further, an efficient IP address setup at the time of address duplication is possible, and the IP address management at the time of duplication can be efficiently put into practice.

In addition, the third embodiment and the fourth embodiment may be combined. Specifically, a choice may be offered between an alternative keyword and an alternative IP address in the dialog box that announces duplication of the IP address.

Further, the present invention is not limited to these embodiments, but variations and modifications may be made without departing from the scope of the present invention.

The present application is based on

Japanese Priority Application No. 2006-019449 filed on Jan. 27, 2006 with the Japanese Patent Office, the entire contents of which are hereby incorporated by reference.

What is claimed is:

1. A network apparatus that requires a network address for identifying the network apparatus in a network, comprising:
an input unit for inputting a keyword for automatic generation of the network address; and
an address generating unit for automatically generating the network address based on the input keyword, the address generating unit including
a keyword verification unit for verifying the keyword, and
an address duplication checking unit for determining whether the network address generated by the address generating unit is duplicated in the network.

2. The network apparatus as claimed in claim 1, wherein the network address is an IP address of IPv6, which is a protocol of a Network layer of Open Systems Interconnection reference model.

3. The network apparatus as claimed in claim 1, wherein the keyword is a desired character string.

4. The network apparatus as claimed in claim 1, wherein the keyword is apparatus setup information that is applied to the network apparatus.

5. The network apparatus as claimed in claim 1, wherein the keyword is network setup information that is applied to the network apparatus.

6. The network apparatus as claimed in claim 1, wherein the keyword is apparatus setup information of an apparatus of setting origin that is connected to the network.

7. The network apparatus as claimed in claim 1, wherein the keyword is network setup information of an apparatus of setting origin that is connected to the network.

8. The network apparatus as claimed in claim 1, wherein the keyword is generated by a replaceable address generating function.

9. The network apparatus as claimed in claim 1, wherein the address duplication checking unit
determines whether the generated IP address is already in use and duplicated in the network,
provides notification if the determination is affirmative, and
offers one or more alternative keywords that are similar to the input keyword, the alternative keywords being capable of generating an available network address.

10. The network apparatus as claimed in claim 1, wherein the address duplication checking unit
determines whether the generated IP address is already in use and duplicated in the network,
provides notification if the determination is affirmative, and
offers an alternative and available network address.

11. An address setup method of setting up a network address required for identifying a network apparatus in a network, comprising:
an inputting step of inputting a keyword for automatically generating the network address; and
an address generating step of automatically generating the network address based on the keyword that is input by the inputting step.
